(19) United States
(12) Patent Application Publication
(10) Pub. No.: US 2013/0001158 A1
(43) Pub. Date: Jan. 3, 2013

(54) BIORETENTION MODULE, METHOD AND SYSTEM FOR TREATING WATER

(76) Inventors: Brendan Condon, Victoria (AU); Marc Alexander Noyce, Victoria (AU)

(21) Appl. No.: 13/579,213

(22) PCT Filed: Feb. 14, 2011
(86) PCT No.: PCT/AU11/00145

§ 371 Date: Sep. 11, 2012

(30) Foreign Application Priority Data
Feb. 15, 2010 (AU) 2010900597
Nov. 26, 2010 (AU) 2010905230

(51) Int. Cl. C02F 3/00; C02F 1/00

(52) U.S. Cl. 210/602; 210/97; 210/151

(57) ABSTRACT

A bioretention module (40) for treating water is provided, which includes a side wall (42), and a base (41) having drainage openings (44) therein, wherein the side wall (42) and base (41) are configured to contain a filtration medium in which plants can be grown. A system for treating water is also provided, which includes one or more bioretention modules (40) placed in a filtration zone (14) to form a filtration layer (22), wherein the modules are configured to be removable from the filtration zone (14). A method of treating water is further provided, which includes the steps of: providing a bioretention module (40); placing filtration media into the module; growing plants to a desired maturity level in the filtration media in the module; preparing a filtration zone at a water treatment site to receive one or more of the modules (40); placing one or more of the modules in the filtration zone (14) such that water to be treated is directed to flow to and be treated by the module(s) (40); and collecting water from the module(s) (40) that has been treated.

### FIELD OF THE INVENTION

This invention relates in general to water treatment, and in particular to a bioretention system and method. The invention is especially useful for treating stormwater and it is convenient to describe the invention in relation to stormwater. However, it should be noted that the invention is not limited to treating stormwater.

### BACKGROUND TO THE INVENTION

Stormwater, and the excess water which results from a storm event, can have a significant impact on the environment. If pollutants are not removed from our urban waterways, the increased nutrient loads can, among other things, lead to blue-green algae outbreaks in the downstream environments which have dramatic consequences to marine ecosystems.

Bioretention is a natural plant based technology used for the removal of sediment, organic material, heavy metals, nutrients and other pollutants contained in stormwater runoff. The concept of using plants to treat storm water pollution is known in the stormwater industry as a type of water sensitive urban design.

Bioretention is the process of biological removal of contaminants or nutrients as fluid, such as water, passes through media or a biological system. Microbes growing within the filtration medium enhance retention and degradation of contaminants from the water which flows into the modules. Contaminants such as heavy metals are caught in the filtration medium. Roots of plants growing in the filtration medium also provide surfaces for biofilm growth from which plants extract nutrients, thus removing them from the filtration medium. In addition, beneficial bacteria on the roots of plants transform soluble pollutants into harmless forms. Therefore bioretention is an environmentally friendly form of water treatment which does not use harmful or toxic chemicals.

In the process of bioretention, following a storm event polluted stormwater is passed through a vegetated sand filter and slowly filters this water to a receiving waterway. Heavy metals are caught in the sand media and beneficial bacteria on the roots of plants transform soluble pollutants to harmless forms. There are various bioretention system designs which exist to attempt to reduce this impact. The most common forms are bioretention pits, commonly referred to as “rain gardens” and may include anoxic zones under the filter media for additional treatment and soil moisture store capacity.

Rain gardens are soil based systems that treat runoff via filtration through a soil media prior to discharging into the drainage system. A typical cross section of a rain garden 100 is shown in FIG. 1 and consists of the following:

Filter layer 110—is a soil layer which acts as a pollutant filter and supports plant growth.

Transition layer 111—is located below the filter layer 110 to separate the filter layer 110 from a drainage layer 112 to avoid clogging of drainage pipes 117.

Drainage layer 112—is located below the transition layer 111, it is a relatively free draining layer containing perforated drainage pipes 117.

Optionally, a rain garden may also contain a mulch layer 114 to suppress weeds and retain moisture within the underlying filter layer. A rain garden may also have a detention zone 115 where rain water can accumulate at the base of exposed sections 118 of the plants 116.

FIG. 2 shows a typical cross-section of a rain garden which includes an anoxic zone 113.

The major pollutant removal mechanisms within rain gardens are: sedimentation in extended detention storage; filtration by the filter media; nutrient uptake by biofilms; nutrient adsorption and pollutant decomposition by soil bacteria; and adsorption of metals and nutrients by filter particles.

There are a number of problems with these existing types of filtration and retention systems. While young plants are growing in these rain gardens, they are not as effective in removal of pollutants as a fully established bioretention system. Some rain garden systems have been observed to have poor establishment of young plants which suffer mortality through sub average rainfall, resulting in desiccation and drying out of seedlings before they reach maturity. These rain garden systems also often require significant maintenance, in particular when first established, and if the necessary maintenance is not undertaken the rain garden will not function correctly, and in the worst case will need to be replaced. Therefore, maintenance costs can often be high using these systems.

A further disadvantage is that existing systems are not able to be easily and typically reset. If there is a problem with a system, the entire system needs to be replaced.

Traditional systems are relatively small and do not have capacity to capture large volumes of stormwater due to shallow extended depths (detention zone) causing water to quickly bypass the treatment facility. If the water bypasses the system or passes directly through the system without treatment, treatment effectiveness is reduced, because bypassed water receives little or no treatment.

Wetlands are an alternative treatment option but require a lot of land. When compared to the size of a rain garden, wetlands are much less effective as a system for treating water.

Any discussion of documents, devices, acts or knowledge in this specification is included to explain the context of the invention. It should not be taken as an admission that any of the material formed part of the prior art base or the common general knowledge in the relevant art in Australia or any other country on or before the priority date of the claims herein.

### SUMMARY OF THE INVENTION

In accordance with a first aspect of the present invention there is provided a bioretention module for treating water. The module includes a side wall, and a base having drainage openings therein. The side wall and base are configured to contain a filtration medium in which plants can be grown.

The side wall is preferably made up of a plurality of connectable wall panels which are lockable with other similar wall panels and which are also lockable with the base. Preferably the connectable wall panels are removable from the base. The side wall is preferably water impermeable.

The base preferably has an open area which is greater than 50% of a total base area. The base is preferably made up of a plurality of base panels.

The module may include at least one divider panel aligned where the base panels meet.

Preferably the connectable wall panels are connected by a tongue and recess configuration, whereby the tongue on one wall panel is inserted into the recess of a second wall panel to connect the wall panels together. The tongue may take the form of a tenon and the recess may be in the form of a mortice, thereby forming a mortice and tenon configuration. It is furthermore desirable that the connectable wall panels are secured to other wall panels and/or the base by a securing means, preferably a screw.

It is desirable for a portion of the base to be shaped to assist removal of the module once it has been placed in position in a bioretention water treatment system.

The module may be made of plastic, preferably recycled plastic. Furthermore, the module is preferably rectangular in plan view and more preferably square in plan view.

In accordance with another aspect of the present invention there is provided a system for treating water including one or more bioretention modules placed in a filtration zone to form a filtration layer, wherein the modules are configured to be removable from the filtration zone.

The system preferably includes a basin and the basin may further include a lining.

Preferably the system for treating water further includes: a detention zone above the filtration layer; a collection mechanism for collecting treated water; and an overflow bypass for directing excess water not able to be treated away from the module(s).

Preferably the system for treating water further includes an anoxic zone.

It is also desirable that the system for treating water further includes a storage mechanism for storing untreated stormwater and/or treated stormwater prior to and after being passed through the bioretention modules.

In accordance with a further aspect of the present invention there is provided a system for treating water including: a filtration layer; a detention zone above the filtration layer; a collection mechanism below the filtration layer for collecting treated water; an overflow bypass for directing excess water not able to be treated away from the filtration layer; at least one storage mechanism for storing untreated storm water and/or treated stormwater.

Preferably the overflow bypass directs excess water not able to be treated into the at least one storage mechanism.

It is also desirable that the system for treating water further includes a means to pre-filter larger particulate matter and debris from untreated stormwater. Preferably the pre-filter means includes at least one of: a large particle and debris filter, or a sedimentation chamber. Preferably the system also includes a second storage mechanism for storing pre-filtered untreated stormwater, which is desirably located below the at least one storage mechanism.

Preferably the system for treating water includes a means for controllably releasing stormwater to receiving waterways and also further includes a means for circulating stored untreated stormwater and/or recirculating treated stormwater back into the system to be treated and/or retreated.

The system may also further include a grate above the detention zone.

In accordance with a further aspect of the present invention there is provided a method of treating water including the steps of: providing a bioretention module; placing filtration media into the module; growing plants to a desired maturity level in the filtration media in the module; preparing a filtration zone at a water treatment site to receive one or more of the modules; placing one or more of the modules into the filtration zone such that water to be treated is directed to flow to and be treated by the module(s); and collecting water from the module(s) that has been treated.

It is desirable that the method for treating water further includes the step of: recirculating treated stormwater back into the system to be retreated. It is also desirable that the method further includes the steps of: filtering large particles from untreated stormwater; collecting and/or storing the filtered untreated stormwater; and circulating the filtered untreated stormwater to be treated by the modules(s).

The modules described above are preferably used in both the water treatment method and system.

Preferably prior to placing a module in the filtration zone, the wall panels are removed.

Preferably the method of treating water further includes the step of growing plants in an horticultural environment, such as a nursery, prior to transporting them to the water treatment site.

It is also desirable that the method for treating water further includes the steps of: monitoring the effectiveness of the module(s); and once a module is deemed ineffective, removing the ineffective module and replacing with an effective module.

The method for treating water preferably further includes the steps of: removing the ineffective module from the filtration zone by cutting roots which have penetrated through a base of the module; and removing the module out of the filtration zone.

### BRIEF DESCRIPTION OF THE DRAWINGS

It will be convenient to further describe the invention with respect to the accompanying drawings which illustrate preferred embodiments thereof. Other embodiments of the invention are possible, and consequently, the particularity of the accompanying drawings is not to be understood as superseding the generality of the preceding description of the invention.

FIG. 1 shows a typical cross section of a prior art rain garden without an anoxic zone.

FIG. 2 shows a typical cross section of a prior art rain garden with an anoxic zone.

FIG. 3 shows a system for treating water according to an embodiment of the present invention.

FIG. 4 shows a system for treating water according to another embodiment of the present invention.

FIG. 5 shows a system for treating water according to yet another embodiment of the present invention.

FIG. 6 shows a cross-section of a part of a system for treating water according to an embodiment of the present invention

FIG. 7 shows a bioretention module according to an embodiment of the present invention.

FIG. 8 is a top view of the module shown in FIG. 7 showing drainage openings in a base of the module.

FIG. 9A is an exploded perspective view of a corner of the module shown in FIG. 7.

FIG. 9B is an alternate exploded view of the corner of the module shown in FIG. 9A.

FIG. 10 shows a bioretention module according to a preferred embodiment of the present invention, including dividing panels.

FIG. 11 shows the bioretention module of FIG. 10 containing plants in a filtration medium.

FIG. 12 shows an exploded view of the bioretention module in FIG. 11.

### DETAILED DESCRIPTION OF PREFERRED EMBODIMENT

Embodiments of the bioretention module, system and method of the present invention will now be described with reference to the accompanying drawings.

Bioretention systems can be used in many different applications where water treatment is needed. This could include local government, council, commercial or even domestic applications. Dirty and/or contaminated water can be treated naturally through a bioretention process which utilises biological removal of contaminants from the water. Contaminants are taken out of the water and converted in the plants to less harmful substances and/or retained in the filtration medium. In an effective system, water that passes through the filtration medium has been treated and has had a significant proportion of contaminants removed.

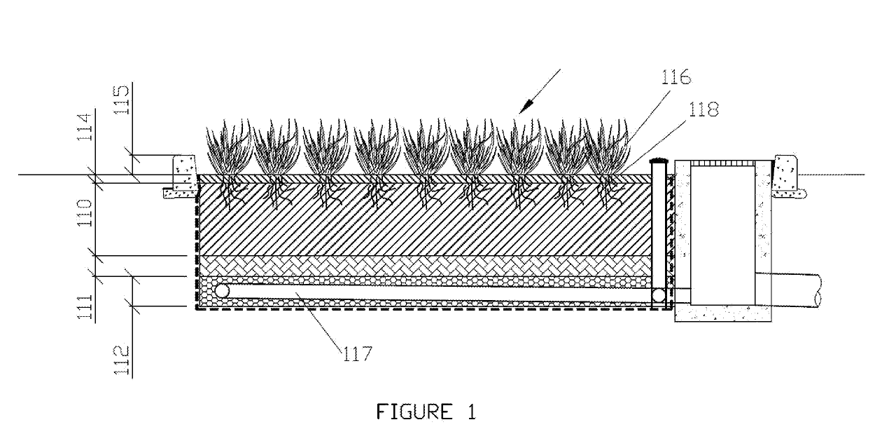

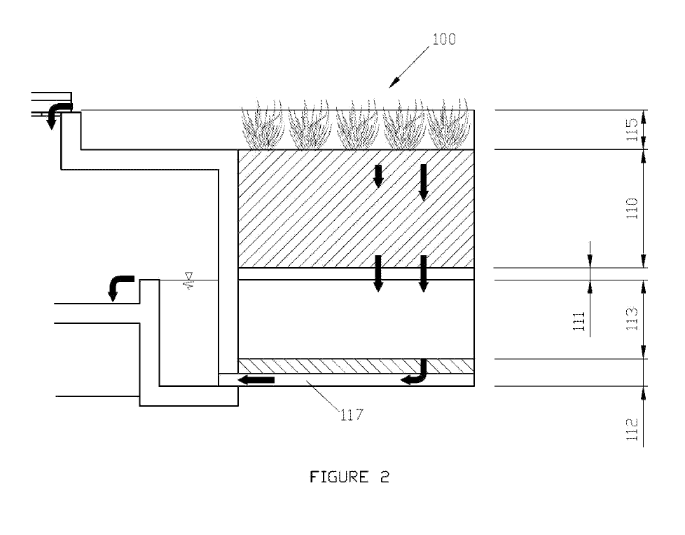

In prior art bioretention systems, such as the rain gardens shown in FIG. 1 or 2, plants 116 are planted haphazardly in soil and are expected to treat water in an effective and efficient manner. However, in many cases they do not. There are many issues which arise in such systems and many disadvantages which result including poor establishment of young plants, ineffectiveness of plants, significant maintenance and if there is a problem with the system, often the entire system needs to be replaced not just a few plants.

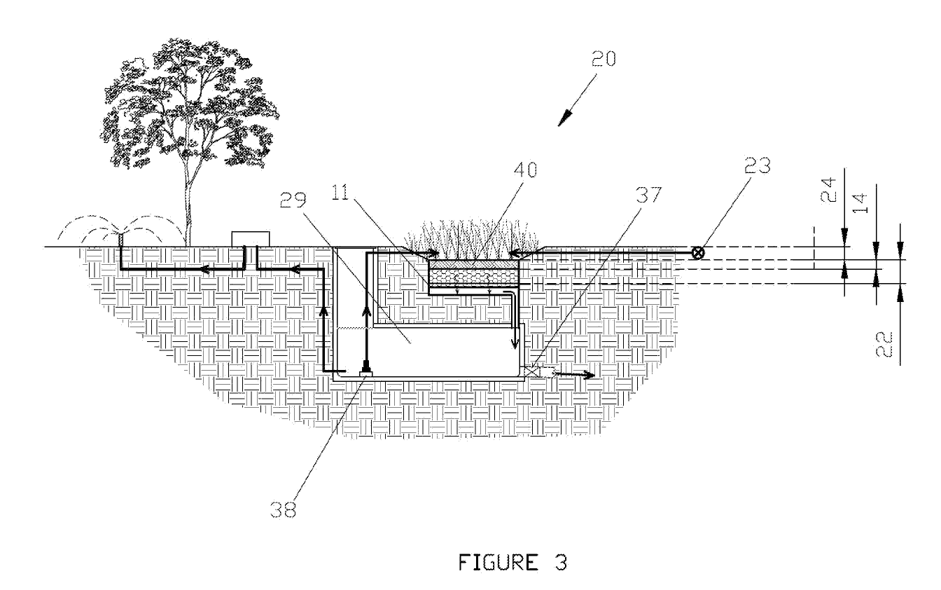

A modular bioretention system for effectively and efficiently treating water according to an embodiment of the present invention is shown in FIG. 3, illustrating an application for treating stormwater. When it rains, excess water not captured, for example, in dams, rain water tanks or on the garden, finds its way to the stormwater system often washing rubbish and other contaminants (such as oil, heavy metals or other pollutants) into stormwater pipes or drains.

The bioretention system 20, shown in FIG. 3, includes one or more bioretention modules 40 placed in a filtration zone 14 to form a filtration layer 22. The modules are configured to be removable from the filtration zone 14.

As shown in FIGS. 3-6, one or more of the following may also be included in the bioretention system: a detention zone 24 above the filtration layer 22; a transition layer 11 below the filtration layer 22; a drainage layer 12 below the transition layer 11; a collection mechanism 27 for collecting treated water; and an overflow bypass 28 which directs excess water, not able to be filtered, away from the module(s). The system may also include an anoxic zone 13. The system may further include a basin 25 in which the above layers may be placed.

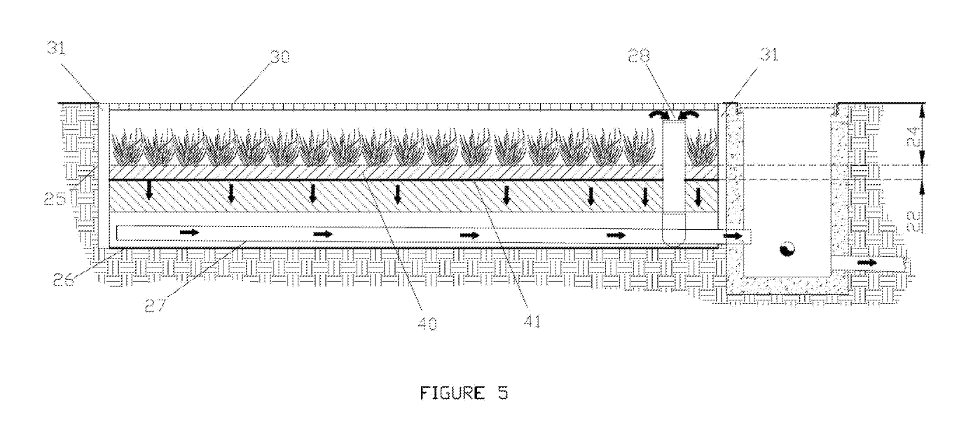

In addition, modules 40 can also be placed in the basin 25, as part of the filtration zone 14, and are configured to be removable from the filtration zone 14. The basin 25 may also have a lining 26, as shown in FIG. 5, to assist with removal of the modules from the filtration zone 14 or to stop leakage occurring beneath the drainage layer 12.

In the bioretention system shown in FIG. 3, dirty and contaminated water flows out of an inlet pipe 23 configured to supply water for the bioretention system from an external source. Preferably, the inlet pipe 23 is connected directly to a stormwater supply, for example a stormwater pipe, and is configured to supply water onto the bioretention modules 40. Stormwater that does not immediately soak into filtration media in the modules may sit in the detention zone 24 until it can be filtered by the module. Excess water not able to be contained in the detention zone, to be eventually filtered and treated by the modules, is directed away from the modules by an overflow bypass (not shown in FIG. 3, item 28 in FIG. 5). The excess water directed to the overflow bypass may then be captured, and/or stored then recirculated into the system to be treated at a later stage.

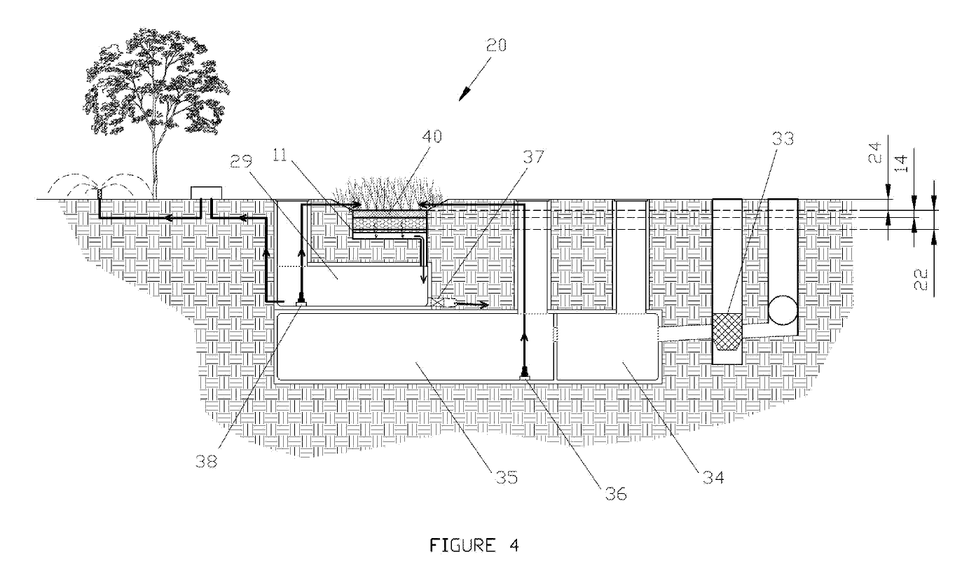

A particularly preferred embodiment of the present invention is shown in FIG. 4. This embodiment (and that shown in FIG. 5) shows how the bioretention system, is not only useful for treating storm water but also for capturing and storing stormwater for reuse. In the bioretention system shown in FIG. 4, water flowing through the inlet pipe (not shown in FIG. 4, item 23 in FIG. 3) flows through a pre-filtering stage. The pre-filtering stage may include at least one of: a means for filtering large particles or objects (including debris), such as a gross pollutant trap (GPT) 33, a sedimentation chamber 34 or a primary holding tank 35. In FIG. 4 the pre-filtering stage is arranged such that stormwater is supplied to the GPT 33, which in turn supplies filtered water to the sedimentation chamber 34, which in turn supplies the primary holding tank 35. However, any one of these components may be omitted as required. The primary holding tank 35 is further configured to supply water to the modules 40. In FIG. 4 water is supplied to the modules 40 from the primary holding tank 35 by a pump 36.

The gross pollutant trap (GPT) 33 may be of a conventional form. It is included in the system to remove clogging debris and is often a primary mechanism for such contamination removal.

The sedimentation chamber 34 is modular and made of concrete. Advantageously, the sedimentation chamber 34 provides a mechanism to reduce energy from the stormwater inflow and provides a stilling chamber to collect sand, silt particles, floating debris and oils, minimising suspended solids from entering the primary holding tank 35. The sedimentation chamber 34 has access points (not shown) at each end to allow easy removal of accumulated sediment via eductor trucks or other methods (not shown).

The primary holding tank 35 is configured to store the pre-filtered water from which gross pollutants and coarse sediments have been removed. The primary holding tank 35 is also modular to allow flexibility in shape and volume. The primary holding tank 35 can hold a volume of water corresponding to a 3 month stormflow event, however it may hold more or less as required. Access points are provided (not shown) in the primary holding tank 35 to allow entry for clean out of accumulated silt. It is also desirable that the tank 35 be configured to direct the bulk of any accumulated silt into easy to access locations.

As shown in FIG. 4 the pump 36 is submersible and is located in the primary holding tank 35 to provide water to the modules 40. The pump includes a floating offtake (not shown) such that during operation of the pump, the cleanest water (being water located near the top surface of the stored water) is removed from this offtake point in the primary holding tank 35. Following a rainfall event the pump should not be operated until sufficient time has passed to allow finer silt particles to settle below the pump's 36 offtake point.

The pre-filtered water pumped from the primary holding tank 35 by the pump 36 may then follow the same process in the system as outlined for FIG. 3. That is, the pumped pre-filtered water is supplied onto the bioretention modules 40. The pre-filtered stormwater that does not immediately soak into filtration media in the modules will sit in the detention zone 24 until it can be filtered by the module. Excess water not able to be contained in the detention zone, to be eventually filtered and treated by the modules, is directed away from the modules by an overflow bypass (not shown in FIGS. 3 and 4, item 28 in FIG. 5). The excess water directed to the overflow bypass is then captured, and/or stored then recirculated into the system to be treated at a later stage.

In an alternative embodiment (not shown) the modules may be omitted and a more conventional rain garden may be constructed over the location of the reuse tank. However, this arrangement is less preferred.

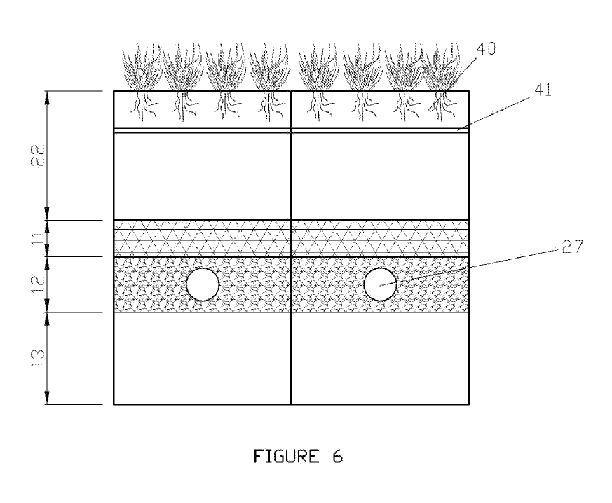

Treated water which has passed through the filtration layer 22, transition layer 11 and drainage layer 12 is then collected in a collection mechanism 27 (shown in FIGS. 5 and 6). The system may further include a storage mechanism 29, also referred to as a reuse tank, for storing the treated water (as shown in FIGS. 3 and 4). Treated water which has been stored may be transported for use elsewhere, or alternatively, recirculated back into the system for further treatment. In FIG. 4, the reuse tank 29 is positioned above the primary holding tank 35 to allow gravity drainage of filtered water to a downstream waterway as a purge function. In FIGS. 3 and 4, recirculation of filtered water is achieved via a pump 38 in the reuse tank 29 which transports water back onto the modules 40 for further treatment. In addition (or alternatively), the system includes a means for controllably releasing stormwater to receiving waterways for example via an outflow mechanism 37 (FIGS. 3 and 4) or overflow bypass 28 (FIG. 5). Irrigation water, for use in gardens and the like, is sourced from the reuse tank 29 only.

Other functions such as UV disinfection, pump control or irrigation distribution may occur or be controlled at a location near the primary tank 35. The controls and irrigation pumps are preferably housed in a secure container (not shown) which provides an access point for all electrical control elements.

Bioretention systems may be used in particular applications, such as car parks, industrial estates or roadways (FIG. 5). Bioretention systems in such applications need to be unobtrusive and conventional bioretention systems are therefore usually confined to the outer perimeter of the car park. The bioretention system shown in FIG. 5 can be used for a car park application, but is not necessarily confined to the outer perimeter of the car park. FIG. 5 shows the system can further include a grate 30 which sits above the bioretention modules, and can be secured to the top of the basin 25 and/or concrete walls 31 placed in the basin 25 and/or to any other structure. In this way, the bioretention modules can be built as part of a load bearing bioretention system which is placed below the ground level of the car park. Cars are therefore able to drive over the grate without damaging the plants, bioretention modules or system, but the bioretention modules are still able to treat water.

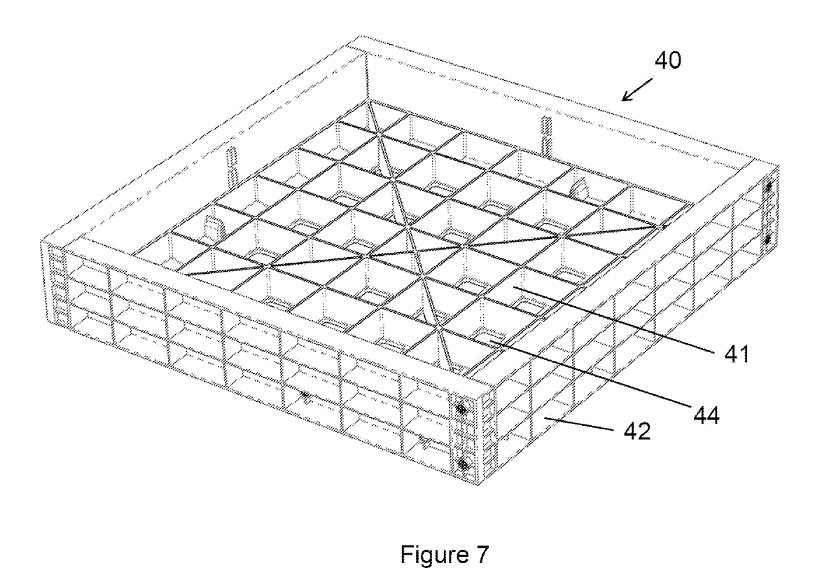

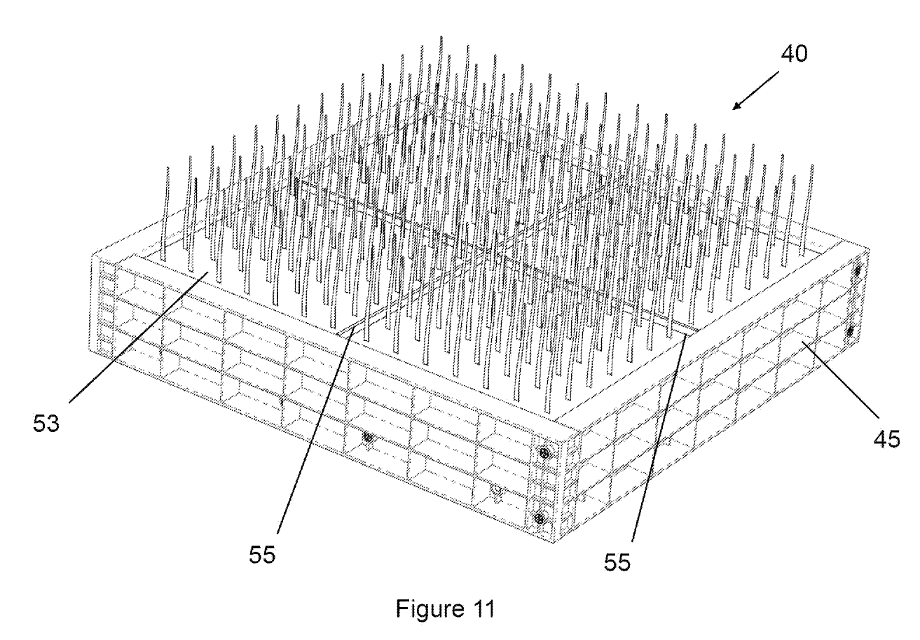

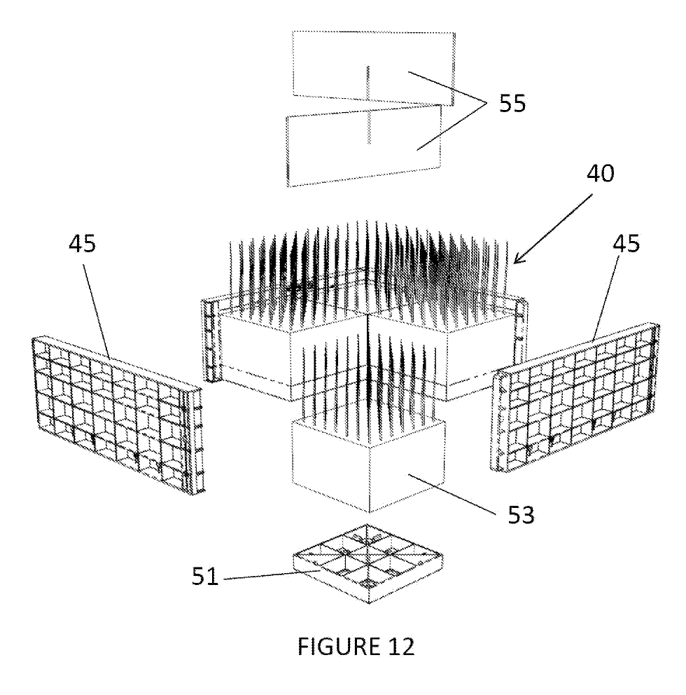

Bioretention modules can be used in bioretention systems such as those described above. A preferred embodiment of a bioretention module according to the present invention is shown in FIGS. 7 to 12. The module 40 includes a side wall 42, and a base 41 having drainage openings 44 therein. The side wall 42 and base 41 are configured to contain a filtration medium in which plants can be grown, as shown in FIGS. 11 and 12. The side wall can be water impermeable.

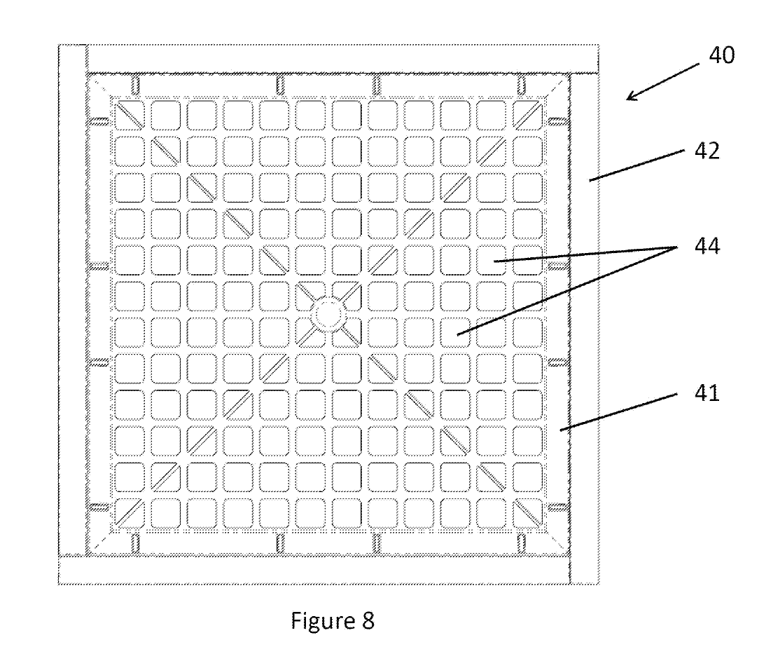

As shown in FIG. 8, the base 41 has an open area 44, formed by the drainage openings, which is greater than 50% of a total base area. This allows treated water to pass through the module at an efficient rate and to maintain hydraulic conductivity, so that the module does not retain too much water in the filtration medium. If the module retains too much water it will not be effective or efficient at allowing drainage of the water. The drainage openings are arranged to ensure that the module allows water to be treated and passed through the system while still retaining the filtration medium and the plants in the module. Plant root systems of established plants hold the filtration medium together so that it does not “fall” through the drainage openings or “fall” out the sides, or have the sides collapse if or when the side wall is removed from the module.

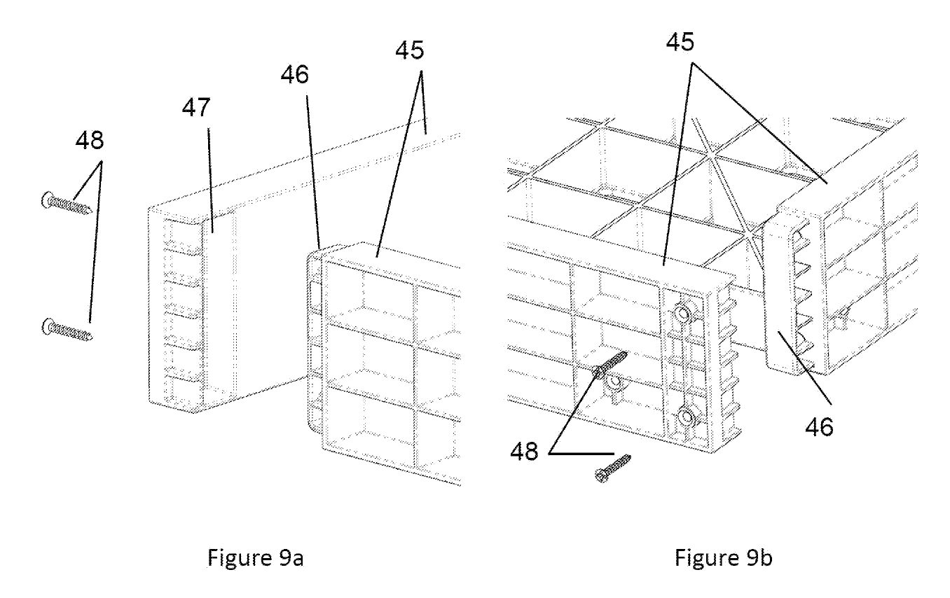

The side wall 42 is made up of a plurality of connectable wall panels 45 which are able to be joined to other similar wall panels and which are also able to be joined to the base 41. The connectable wall panels 45 are preferably connected in a tongue 46 and recess 47 configuration, whereby the tongue 46 on one connectable wall panel 45 is inserted into the recess 47 of a second connectable wall panel 45 to connect the wall panels together. The tongue and recess configuration can be further described as a mortice and tenon configuration. As shown in FIGS. 9A and 9B the tongue 46 may be in the form of a tenon and the recess 47 may be in the form of a mortice. The connectable wall panels 45 can be secured to other wall panels 45 and/or the base 41 by a securing means 48, preferably one or more screws (as shown in FIGS. 9A and 9B).

In an alternative embodiment (not shown) of a bioretention module, the tongue on the connectable wall panels may have a self locking arrangement including a tapered end or hook which locks the tongue into the recess, thereby connecting two wall panels together. The base may be connected to the side wall panels by a clipping arrangement which is self locking. The connectable wall panels can additionally be secured to other wall panels and/or the base by a securing means, preferably a screw.

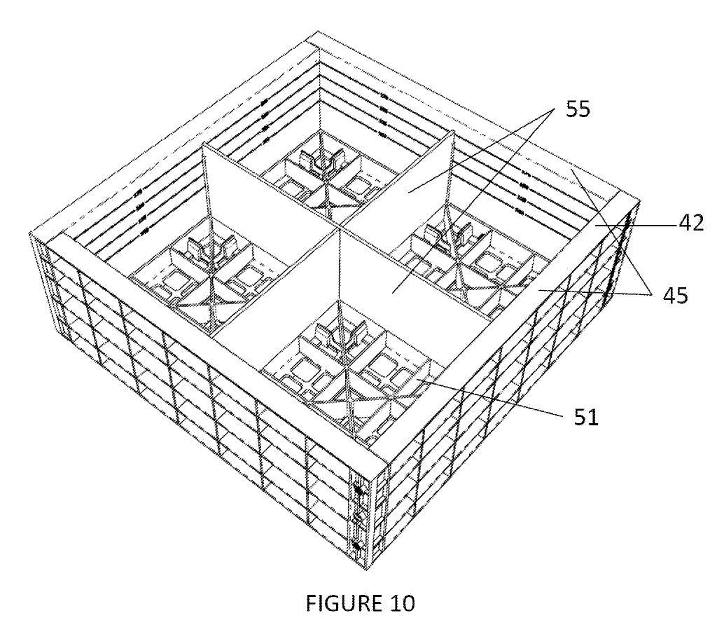

The base 41 of the bioretention module may also be made up of a plurality of abutting base panels 51, as shown in FIGS. 10 and 12. Dividing panels 55 which align with where the base panels 51 abut one another can be seen in FIGS. 10 and 12. These dividing panels 55 are inserted into the module 40 prior to planting the filtration medium and immature plants in the module. It is desirable to have different sizes (or shapes) of bioretention modules to fit different size treatment sites. The dividing panels 55 and base panels 51 allow a module to be divided into smaller sections 53 which can be planted in smaller or more awkward areas within the system, without needing to manufacture different module sizes.

Different water treatment applications may require different amounts of filtration medium to be placed in a module or for ultimate use in a system. The modules may have a depth indicator on the inside of the side wall to indicate how much filtration medium has been placed in the module. This feature may be present in any embodiment of the bioretention module described above.

Each of the wall panels is preferably identical and each of the base panels is also preferably identical. This is advantageous because only one wall panel and base panel need to be manufactured which reduces costs. Furthermore, the modular construction of the module side wall and the base allows the modules in their unassembled form to be “flat packed”, therefore using less space, for efficient transportation and storage which also reduces costs.

The bioretention module can be made of plastic, preferably recycled plastic, so that it is durable and able to remain in a system for a period of years. Being made of plastic or polymer material also means that it is light weight which assists in reducing transportation costs. As shown in FIGS. 7 to 12 the module is rectangular in plan view and more preferably square in plan view. This shape allows an array of modules to be more easily arranged.

A method of treating water according to an embodiment of the present invention includes: providing a bioretention module; placing filtration medium into the module; growing plants to a desired maturity level in the filtration medium in the module; preparing a filtration zone at a water treatment site to receive one or more of the modules; placing one or more of the modules in the filtration zone such that water to be treated is directed to flow to and be filtered by the module(s); and collecting water from the module(s) that has been treated. Any one of the embodiments of the bioretention module described above may be used in such a method for treating water.

Preferably the system includes a basin where the modules can be placed. It is desirable in particular applications, such as a car park, that the basin also has a lining to help define the boundary of the basin and prevent treated water from leaking. Lining material placed on the sides of the basin can help to guide where the modules should be placed. In addition, the system may have an anoxic zone under the drainage layer.

Plant types such as sedges, grasses or rushes, ground covers or small shrubs can be grown in the filtration medium that is placed inside the modules. These plants are generally chosen for bioretention applications because, once established, little or no maintenance is required.

While the plants are growing in the modules, the side wall provides a structure so that the filtration medium and plants do not fall out. The module side wall makes it easier to transport the module with plants growing in it to the desired location when needed.

Prior to placing the modules containing established plants and filtration medium in the filtration zone or basin, the connectable side wall panels are able to be removed from the base. As the plants grow in the filtration medium in the module, their root systems also grow and help to establish the plants in the filtration medium. The root systems of the plants hold the filtration medium together (also known as the plants being root bound), so that even when the side wall panels are removed from the module, leaving the base as a support, the plants and filtration medium stays in place.

Preferably the plants are grown in the bioretention modules in an horticultural environment for approximately 6 to 9 months (or to a desired maturity level) until they are well established and root bound, prior to transportation to, and placement in, a water treatment system.

In the horticultural environment, while the plants are still immature and growing, the modules may be placed on plastic, concrete or other impermeable surfaces (but not water, soil or other such mediums) to stop the plant roots penetrating through the base and attaching to or penetrating the substrate underneath. Alternatively, the modules may be placed on pallets whereby a large proportion of the module base is exposed to air. Roots cannot survive in air. Therefore, as the roots grow or penetrate through the base and are exposed to air, the roots outside of the module (that is, those that have penetrated through the base) will die off. This is referred to as air pruning.

When the modules containing the mature plants are placed in a system, the modules and plants are instantly fully functional and able to effectively treat water. Therefore little or no maintenance is required once they are placed in the system which is very advantageous.

Prior art systems, once they cannot effectively or efficiently treat water, must be completely dug up, and this may include digging up any drains or other infrastructure which may be part of the system. This is often necessary because the plant roots spread, penetrating down to the drainage level, tangling themselves in or around the system infrastructure and often destroying existing pipes or other infrastructure. Therefore, when the plants are removed they can further damage the pipes and drains. Alternatively if the roots are wrapped around the pipes and drains when the plants are dug or pulled up, the pipes and drains may be pulled up as well.

In the water treatment system described above the modules are used until they are no longer effective, this could be in excess of five years. As such, the method for treating water may further include monitoring the effectiveness of the module(s); and once a module is deemed ineffective all that is needed is for each ineffective module to be removed and replaced with an effective “fresh” module. The plants which are pre grown in the modules described above have the majority of their plant roots contained in the module (contained root mass). Roots which extend through the base are uncontained roots and are not as strong as the contained root mass. To remove a module from the system the roots that have grown through the drainage openings in the base need to be sheared. In this way, unlike conventional systems, it is not necessary to dig up the entire system. It is only necessary to remove filtration medium as far down as the base, this includes approximately the top 200 mm of filtration medium, the base 41 of the module and plants contained within the system. Once removed, it is then replaced with an effective module which contains mature plants with good root development. The base 41 of the module is not completely flat. It is shaped to assist removal of the module by making it easier for the roots under the base to be cut. Once the roots have been cut, the module can then be lifted out of the system and replaced with a “fresh” effective module. The module may be removed by means such as an excavator or shovel.

The modular nature of the system described above coupled with the plants being grown in the bioretention modules prior to installation in a water treatment system means that, unlike conventional bioretention systems which take up to 12 months to become established, the system described above is fully functional and effective on installation.

It will be appreciated by persons skilled in the art that other embodiments and arrangements of the system are also possible within the spirit and scope of the invention described herein or as claimed in the appended claims.

1-24. (canceled)

25. A system for treating water including:
a filtration layer;
a detention zone above the filtration layer;
a collection mechanism below the filtration layer for collecting treated water;
an overflow bypass for directing excess water not able to be treated away from the filtration layer;
a storage mechanism for storing untreated water;
a second storage mechanism for storing treated water; and
a means for:
(i) supplying stored untreated water to said system to be treated; and/or
(ii) recirculating treated water back into said system to be retreated.

26. A system for treating water according to claim 25, wherein the overflow bypass directs excess water not able to be treated into the storage mechanism for storing untreated water.

27. The system for treating water according to claim 25, further including a means to pre-filter larger particulate matter and debris from untreated water.

28. The system for treating water according to claim 27, wherein the pre-filter means includes at least one of: a large particle and debris filter, or a sedimentation chamber.

29. The system for treating water according to claim 25, further including a means for controllably releasing stored treated water to receiving waterways.

30. The system for treating water according to claim 25, further including a grate above the detention zone.

31. The system for treating water according to claim 25, wherein the system further includes an anoxic zone.

32. The system for treating water according to claim 25, wherein the storage mechanism for storing untreated water and/or the storage mechanism for storing treated water includes one or more tanks.

33. A bioretention module for treating water, the module including a side wall, and a base having drainage openings therein, wherein:
the side wall and base are configured to contain filtration media in which immature plants can be grown into mature plants; and
the side wall is removably connectable with the base, allowing the mature plants, the filtration media and the base to be transported without the side wall for installation in a bioretention system.

34. The bioretention module according to claim 33, wherein a combined area of the drainage openings in the base of each module is greater than 50% of a total base area.

35. The bioretention module according to claim 33, wherein the side wall is made up of a plurality of connectable wall panels which are lockable with other similar wall panels and/or the base.

36. The bioretention module according to claim 35, wherein the connectable wall panels are connected by a tongue and recess configuration, whereby the tongue on one connectable wall panel is inserted into the recess of a second connectable wall panel to connect the wall panels together.

37. The bioretention module according to claim 35, wherein the connectable wall panels are secured to other wall panels and/or the base by securing means.

38. The bioretention module according to claim 33, wherein a portion of the base is shaped to assist removal of the module once it has been placed in position within a bioretention system.

39. The bioretention module according to claim 33, wherein the module is made of plastic, preferably recycled plastic.

40. The bioretention module according to claim 33, wherein the module is rectangular in plan view and preferably square in plan view.

41. The system for treating water according to claim 25, wherein the filtration layer is formed by one or more bioretention modules placed in a filtration zone, and wherein the modules are configured to be removable from the filtration zone.

42. The system for treating water according to claim 41, wherein the bioretention modules are modules as defined in claim 33.

43. A method of treating water including the steps of:
providing a bioretention module;
placing filtration media and immature plants into the module;
growing plants to a desired maturity level in the filtration media in the module, wherein the plants are grown in an horticultural environment and then transported to a water treatment site;
preparing a filtration zone at the water treatment site to receive one or more of the modules;
placing one or more of the modules in the filtration zone of the water treatment system according to claim 41 such that water to be treated is directed to flow to and be treated by the module(s); and
collecting water from the module(s) that has been treated.

44. The method of treating water according to claim 43, further including the step of once a module is deemed ineffective, removing the ineffective module by cutting roots which have penetrated through a base of the module and replacing with an effective module.

45. The method of treating water according to claim 43, further including any one or more of the steps of:
filtering untreated water for large particles;
collecting and/or storing the filtered untreated water;
supplying the filtered untreated water to the module(s) to be treated; and
recirculating treated water back into said system to be retreated.

46. The method of treating water according to claim 43 wherein the bioretention module(s) are module(s) as defined in claim 33.

47. The method for treating water according to claim 46, wherein prior to placing the module(s) in the filtration zone, the side wall is removed.
